(19) United States
(12) Patent Application Publication
(10) Pub. No.: US 2005/0007457 A1
(43) Pub. Date: Jan. 13, 2005

(54) Method and apparatus for improved camera control

(76) Inventor: James A. Karlock, Portland, OR (US)

Correspondence Address: DELLETT AND WALTERS, P. O. BOX 2786, PORTLAND, OR, 97208-2786, US

(21) Appl. No.: 10/413,896

(22) Filed: Apr. 14, 2003

(51) Int. Cl. H04N 5/232

(52) U.S. Cl. 348/211.4

(57) ABSTRACT

A method and apparatus for improved camera control is achieved by providing two sets of zoom controls, each with a speed control, sensing the power down of the camcorder and issuing a power on command or issuing a run/pause sequence after a predetermined length of time in pause, and reading the mode data byte from the camcorder and switching to a second set of commands.

### BACKGROUND OF THE INVENTION

This invention relates to video camera control.

Many video camera/video tape recorder combinations, known a camcorders, have a remote control jack designed to both accept commands and output status information. One example is the “Control L” protocol found on many Sony brand camcorders. This is a three wire scheme which includes power from the camera, ground and one bi-directional signal line operating at 9600 baud. Many vendors make remote control units using this scheme.

### SUMMARY OF THE INVENTION

A first object of the present invention is to provide a more versatile remote controller that allows presettable zoom speeds and to allow different speeds for zoom in and zoom out.

A second object of the present invention is to automatically keep the camera powered up, even if the camera would ordinarily power down after a period of time in pause.

A third object of the present invention is to sense when the user puts the camcorder in the play mode and supply the appropriate set of controls.

The foregoing objects may be achieved by 1) providing two sets of zoom controls, each with a speed control, 2) sensing the power down of the camcorder and issuing a power on command or issuing a run/pause sequence after a predetermined length of time in pause and 3) reading the mode data byte from the camcorder and switching to a second set of commands.

The subject matter of the present invention is particularly pointed out and distinctly claimed in the concluding portion of this specification. However, both the organization and method of operation, together with further advantages and objects thereof, may best be understood by reference to the following description taken in connection with accompanying drawings wherein like reference characters refer to like elements.

### BRIEF DESCRIPTION OF THE DRAWINGS

FIG. 1 shows the control arrangement;

FIG. 2 is a schematic of the preferred implementation;

FIG. 3 shows the data format of one complete data block; and

FIG. 4 shows the data format of one byte within the data block.

### DETAILED DESCRIPTION

The system according to a preferred embodiment of the present invention comprises a method and apparatus for improved camera control.

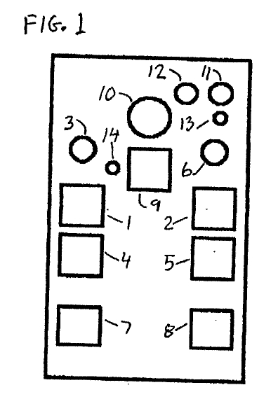

FIG. 1 shows the user controls on the front panel of a camera control in accordance with the present invention. Zoom In push button switch, 1, and Zoom Out push button switch, 2, operate the zoom lens at a zoom speed determined by zoom speed control, 3. A second set of push button switches and zoom speed control, 4, 5, 6 allow the user to set a second, different zoom speed before hand and then select whichever one to use by choosing which zoom push button switch to use. The zoom speed can be changed at any time, including during a zoom, by adjusting one of the speed controls, 3, 6. The user can also change speed during a zoom by operating another of the four pushbutton zoom switches 1,2,4,5. One can zoom in with one set of controls set to a given zoom speed and zoom out with the second set of controls set to a different zoom speed. The focus can be adjusted by pressing one of the two focus push button switches (one to focus closer and one to focus further away), 7, 8. A recording may be started or stopped by pressing the record push button switch, 9, and focus may be set to manual or automatic with push button switch 10. The camera power can be turned off with push button switch 11 and back on with push button switch 12. Light emitting diodes, 13 and 14 serve as a pilot light and record indicator. Said record indicator blinks in pause and is on solid in record.

Most current camcorders have two distinct modes: camera mode where the unit functions as a combination of camera and recorder and VCR (short for video cassette recorder) mode where the unit functions as a video cassette recorder/player. In this mode it can play a tape, usually including forward and reverse scan, rewind and fast forward. Some units can even record from an external video signal in this mode. The present invention can sense whether the user has selected the camera or VCR mode and select the corresponding set of functions for the single set of push button switches. The above front panel description is for the when the camcorder is in the camera mode, when it is in the VCR mode the buttons are redefined as follows:

2 becomes pause, 4 becomes rewind, 5 becomes fast forward, 7 becomes stop and 8 becomes play.

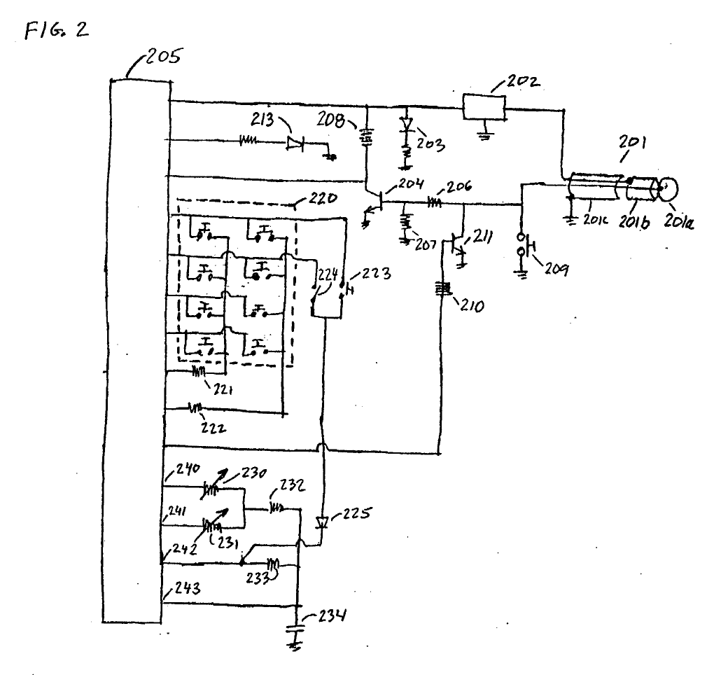

FIG. 2 is a schematic diagram of the preferred embodiment. Connector 201 plugs into the remote control jack of the camcorder. The connector tip 201a carries the data, while the ring 201b receives power from the camera and the sleeve 201c is ground. Power, from the ring, is applied to a voltage regulator integrated circuit 202, whose output powers a light emitting diode pilot light 203, supplies collector bias to input amplifier 204 via resistor 208 and powers microprocessor 205.

Data from the tip of the plug is attenuated by a resistive divider formed by resistors 206 and 207 then applied to transistor 204 which supplies data at logic levels 0 and 5v to the microprocessor 205. Shorting the data line to ground with pushbutton switch 209 provides the “power on” command to the camcorder. Microprocessor 205, through resistor 210, drives transistor 211 which inserts data into the data stream from the camcorder on the tip 201a of connector 201. Microprocessor controlled LED 213 serves as a record indicator when made to light continuously and as a pause indicator when made to blink.

Switch array 220 is an array of switches arranged in rows and columns forming a conventional, well known scanned array. Resistors 221 and 222 limit current if two buttons are pressed at once. Switches 224 and 223 are added switches that share microprocessor 205 pins with the scanned array, but are not part of it, instead they are individually queried. Diode 225 allows one pin to read these two switches. All of these switches appear on the front panel except SPST switch 224 which is on the side of the cabinet, accessible through a hole and serves as the on-off switch for the keep-alive feature.

Components 230 through 243 read the position of the two zoom speed controls, 230 and 231 while resistor 233 is a reference used to calibrate out component variations. This is a well known scheme that works as follows: First the capacitor is discharged by placing microprocessor pins 240 through 242 at ground for a sufficient period of time. Second pins 240 and 241 are set to be inputs so as be a high impedance and pin 242 is set high. This causes capacitor 234 to ramp in a positive direction as it charges at a rate determined by reference resistor 233. At some point the upper threshold of pin 243 is reached and the microprocessor records the length of time taken to reach this threshold. Third, the capacitor is again discharged. Fourth, the charging process is repeated but with pin 240 taken high (and pin 242 kept high impedance) so as to charge the capacitor through zoom speed control 230. The ratio of this charge time to the charge time for reference resistor 233 provides an indication of the position of this user control 230. Fifth, the discharge, charge process is repeated for zoom speed control 231. Resistor 232 serves to limit the charging current when resistor 230 or resistor 321 is set to its minimum resistance position.

### Software Description

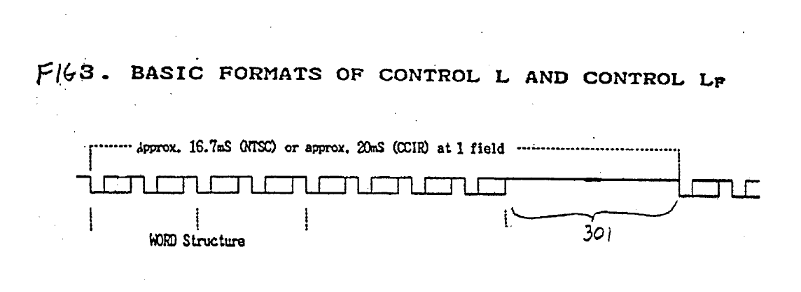

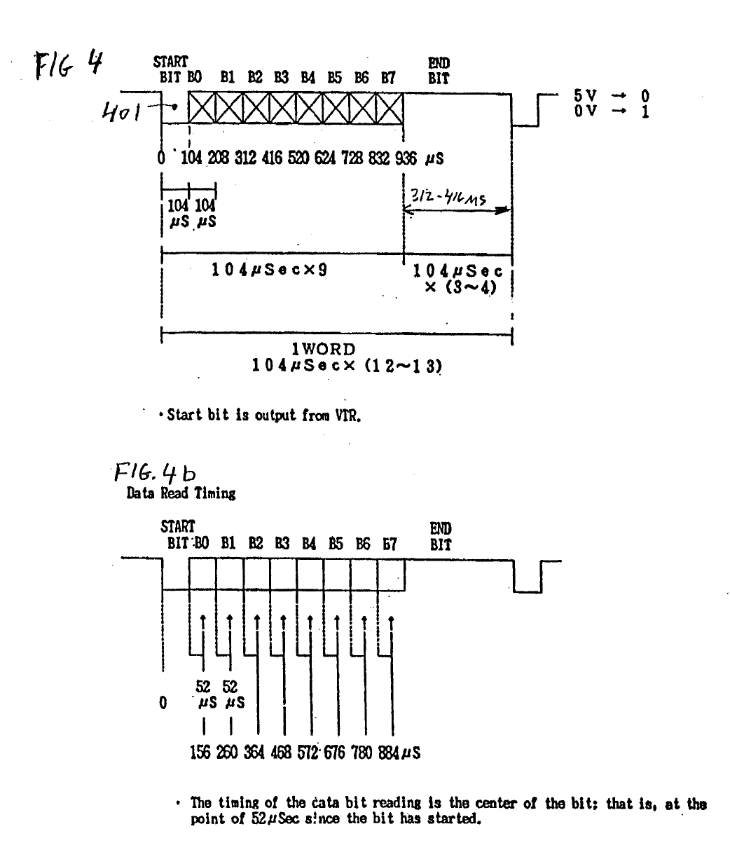

It is believed that there is nothing unusual about the software used in microprocessor 205, however a brief description follows. FIG. 3 shows one frame of data from the camcorder which is made up of eight bytes of eight bits as detailed in FIG. 4. B0-B7 are the data bits while 401 is the start bit. Some of the data bytes are data from the camcorder and some are intended to be provided by external devices like the present invention, however all start bits are supplied from the camcorder. The eight byte frame is repeated once per video field and occupies less time than the video field, leaving a period of no activity between frames, 301 of FIG. 3, which is used for key scan and other functions in the present invention.

The microprocessor waits for 600 us of no activity to detect the inter frame time, 301 of FIG. 3 at the end of the frame, then it waits for the first start bit. Once the first start bit is detected, data bits B0-B7 (FIG. 4) are either read to variables or data is outputted, from stored variables, at the appropriate times as shown in FIG. 4b. The data from the camcorder is decoded and used to set flags corresponding to various camcorder modes of interest: play, record, paused record, stop.

Referring to FIG. 2, after the last data byte is read, the microprocessor 205 reads the SPST switch 224 then the push button switch 223 by supplying a logic high to the appropriate microprocessor 205 pin and then testing microprocessor 205 pin 242 for the presence of a high. Next the zoom controls are read as described above. A lookup table provides the proper speed code to output to the camcorder based on the measured resistance of the control. The next step is to scan the key array 220 then, depending on the status of the, above described, play flag, generate an output code appropriate for whichever mode the camcorder is in—either the camera mode or the VCR mode These, like the zoom speed are stored in variables, the outputted at the proper time within the camcorder data block.

Next an ordinary routine turns the LED on and off to cause a blinking effect when the camcorder data output indicates a paused record state. If the data indicates record then the LED is left on solid. The on-off cycles are counted by a software counter and when the count indicates a time a little before the camcorder would power down from being in pause “too long”, a record command is issued. As soon as the camcorder responds by outputting a record mode code, the present invention responds by issuing a pause command. The counter is also reset to begin another timed period. An alternative method of defeating the camcorder's pause time-out is to look at the camcorder's outputted data for the stop mode (which is outputted as the camera is powering down) and shorting the data line, by turning on transistor 209, for a period of time sufficient to turn the camcorder back on.

While a preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

1. A method of switching the action of a single set of control switches from camcorder control functions to VCR control functions on a remote control apparatus connected to a camcorder, comprising the steps of:
decoding the data stream from said camcorder,
detecting a code indicating that the camcorder is in VCR mode,
selecting the alternate set of control codes to output when any key is activated, so as allow one set of controls to serve different functions the VCR mode than in the camcorder mode.

2. A method of keeping a camcorder in record pause, when it would otherwise power down after a given length of time comprising the steps of:
decoding the data stream from said camcorder;
keeping track of the length of time that said camcorder has been in pause with a timer;
issuing a run command;
waiting for the camcorder to respond;
issuing a pause command;
restarting said timer, so as to keep the camcorder continuously in a pause mode, except for brief periods of time in run.
